(19) United States
(12) Patent Application Publication
(10) Pub. No.: US 2008/0270196 A1
(43) Pub. Date: Oct. 30, 2008

(54) Transforming A Usecase Scenario To Its Process Model

(76) Inventor: Seiki Yaegashi, Tokyo (JP)

Correspondence Address: LIEBERMAN & BRANDSDORFER, LLC, 802 STILL CREEK LANE, GAITHERSBURG, MD, 20878, US

(21) Appl. No.: 11/739,226

(22) Filed: Apr. 24, 2007

(51) Int. Cl. G06F 9/06

(52) U.S. Cl. 705/7

(57) ABSTRACT

A method and system are provided for generating a process model from a usecase description model. A model class diagram is defined for formalizing and expressing the usecase description model. From the formalized and expressed usecase description model, an algorithm is defined and invoked to convert the usecase description model to a process model.

### BACKGROUND OF THE INVENTION

1. Technical Field

This invention relates to a component based layer architecture and development of the flow control layer therein. More specifically, the invention relates to defining the usecase description model and creating a process model of the flow control layer on design from the usecase description.

2. Description of the Prior Art

A usecase is a technique for capturing functional requirements of systems and systems of systems. Usecase allows a description of sequences of events that, taken together, lead to a system doing something useful. Each usecase provides one or more scenarios that convey how the system should interact with actors, e.g. the users, to achieve a specific business goal or function. Usecases are separate and distinct from usecase diagrams.

Each usecase focuses on describing how to achieve a goal or task. A usecase defines the interactions between external actors and the system under consideration to accomplish a goal. An actor is a role that a person or thing plays when interacting with the system. The same person using the system may be represented as two or more different actors because they may be playing two or more different roles.

Usecases treat the system as a black box. Interactions within the system, including responses, are perceived as from outside the system. This forces the author to focus on what the system must do, and avoids the trap of making assumptions about how this functionality will be accomplished.

In an application having a component based layered architecture, there are three layers: flow control, component, and system service. The uppermost layer is the flow control layer that calls components in the component layer. The flow control layer is a non-business logic layer and can be expressed as a process model. By following the usecase driven software development process, the flow control layer can take procedures whose usecase description is prepared with a natural language. From the usecase description, the process model is manually introduced. However, the flow control layer cannot necessarily be re-used for a different application. In one embodiment, it is necessary to develop as many flow control layers as the number of applications. Development of multiple flow control layers is expensive and adds to development time and productivity.

Accordingly, there is a need and desire to reduced development costs associated with the flow control layer.

### SUMMARY OF THE INVENTION

This invention comprises a model and algorithm to transform a usecase scenario into its process model equivalent.

In one aspect of the invention, a method is provided for generating a process model from a usecase description. Initially, a usecase model is defined for formalizing and expressing a usecase description. The defined usecase model is then transformed to a process model. The transformation includes expressing a structured flow from the usecase model having conditional branching and exception processing in the process model.

In another aspect of the invention, a computer system is provided with a processor in communication with storage media. A usecase description of a component based layered architecture is stored in computer readable format in the storage media, and a usecase model is provided to formalize and express the usecase description. A manger is provided to transform the usecase model to a process model. The transformation includes the manager expressing a structured flow from the usecase model with conditional branching and exception processing in the process model.

In yet another aspect of the invention, an article is provided with a computer-readable medium having computer-readable instructions stored thereon executable by a processor. Instructions are provided to define a usecase model for formalizing and expressing a usecase description. Similarly, instructions are provided to transform the defined usecase model to a process model. The transformation instructions include instructions to express a structured flow having conditional branching and exception processing.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a class diagram of a usecase description model.

FIG. 2 is a block diagram of a process model.

FIG. 3 is a flow chart illustrating a process for transforming the usecase model to a process model according to the preferred embodiment of this invention, and is suggested for printing on the first page of the issued patent.

FIG. 4 is a flow chart illustrating a process for inserting an alternate scenario to a parent scenario.

FIG. 5 is a block diagram of a computer system with a manager to implement instructions to convert the usecase model to a process model.

### DESCRIPTION OF THE PREFERRED EMBODIMENT

### Overview

A model and algorithm are provided for generating a process model from a usecase description for the purpose of reducing development costs. More specifically, a model structured through the unified modeling language (UML) class diagram is defined for formalizing and expressing the usecase description. From this usecase description model, a model transformation algorithm is converted to a process model.

### Technical Details

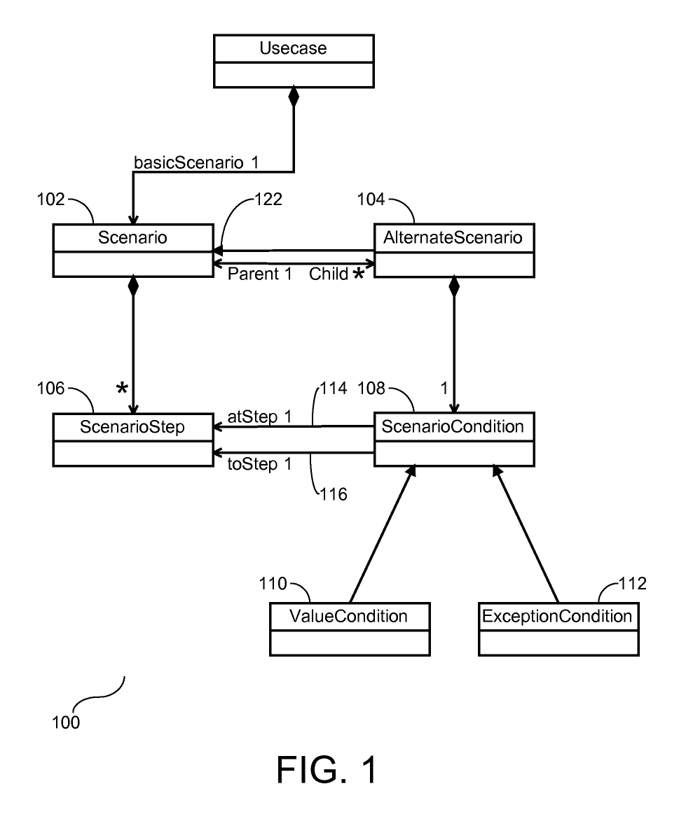

FIG. 1 is a class diagram (100) of a usecase description model. The usecase description has a basic scenario (102), also known as a parent scenario. The basic scenario (102) may have zero or more alternate scenarios. In the example shown herein, the basic scenario (102) has an alternate scenario (104). In one embodiment, each alternate scenario may have zero or more additional alternate scenarios. An alternate scenario is a subclass of a scenario. In the example shown herein, a solid triangle head (122) denotes that the alternate scenario (104) is a subclass of scenario (102). This implies that alternate scenario (104) can have its own associated alternate scenario(s) (not shown). Each scenario (102) and alternate scenario (104) is composed of multiple steps which are sequentially executed. As shown, basic scenario (102) has scenario step (106). Each of these steps represents events to be concretely executed, such as calling of components, setting of arguments, responding to a user, etc.

The alternate scenario (104) conditions the parent scenario (102), or another 5 alternate scenario to which the alternate scenario refers to. When the condition becomes effective, the steps of the alternate scenario (104) are executed. More specifically, the parent scenario (102) branches to the alternate scenario (104) responsible for the steps of the condition. In an embodiment where there are one or more additional alternate scenarios, the additional alternate scenario (not shown) is a child of the parent alternate 1 0 scenario (104). The alternate scenario has conditions (108). In the example shown herein, the conditions include a value condition (110) and an exception condition (112).

The value condition (110) checks for a value, such as a returned value, and the exception condition (112) which captures an exception. In addition, the alternate scenario (114) has a condition to a step of the parent scenario (102) and a condition to return (114) to the 1 5 parent scenario (102) after execution of the alternate scenario (104). The range from the condition return (112) to the return (114) is called an extension range of the alternate scenario. When there are multiple alternate scenarios, i.e. multiple alternate child scenarios, in one parent scenario, these extension ranges have to be related comprehensively.

Conversely, a process model is a description of a process at the type level. In one embodiment, the same process model is used repeatedly for the development of many applications. One use of a process model is to describe how things must or should be done in contrast to the process itself, which is what happens. Accordingly, a process model is a rough anticipation of what the process will look like, since the process will be determined during actual system development.

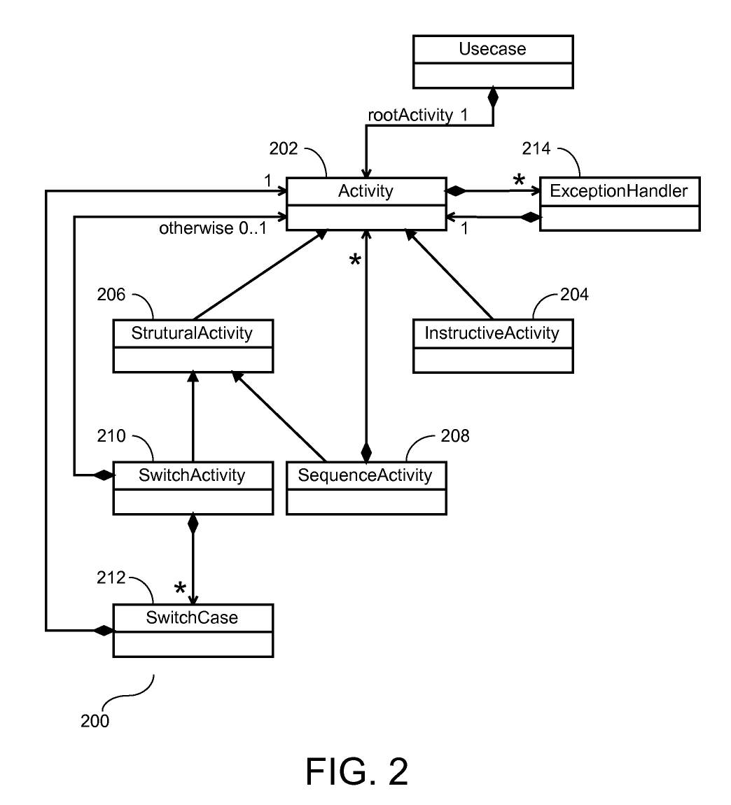

FIG. 2 is a block diagram (200) of a process model. The process is composed of activities. In the example shown herein, there is a root activity (202) with four different categories of activities. The instructive activity (204) to execute processing and the structural activity (206), to structure the flow for the sequence activity (208) and the switch activity (210). The branching has multiple conditions, referred to as switch case (212), and each condition has an activity which is executed when it becomes effective.

More specifically, a switch case is a model to represent a condition which causes a conditional branch to the flow sequence. Switch case has an activity which is to be extracted when the condition is satisfied at switch activity. For example, if A>B then C, else D. The test A>B is the switch case, and C is an activity attached to the switch case. Similarly, the branching can have an activity which is executed when no conditions are fulfilled. In addition, an activity can have one or more exception handlers (214) which execute an activity when a specific condition is captured. An exception handler is defined to intercept a specific kind of exception. More specifically, the exception handler has an activity which is to be executed when the exception is caught.

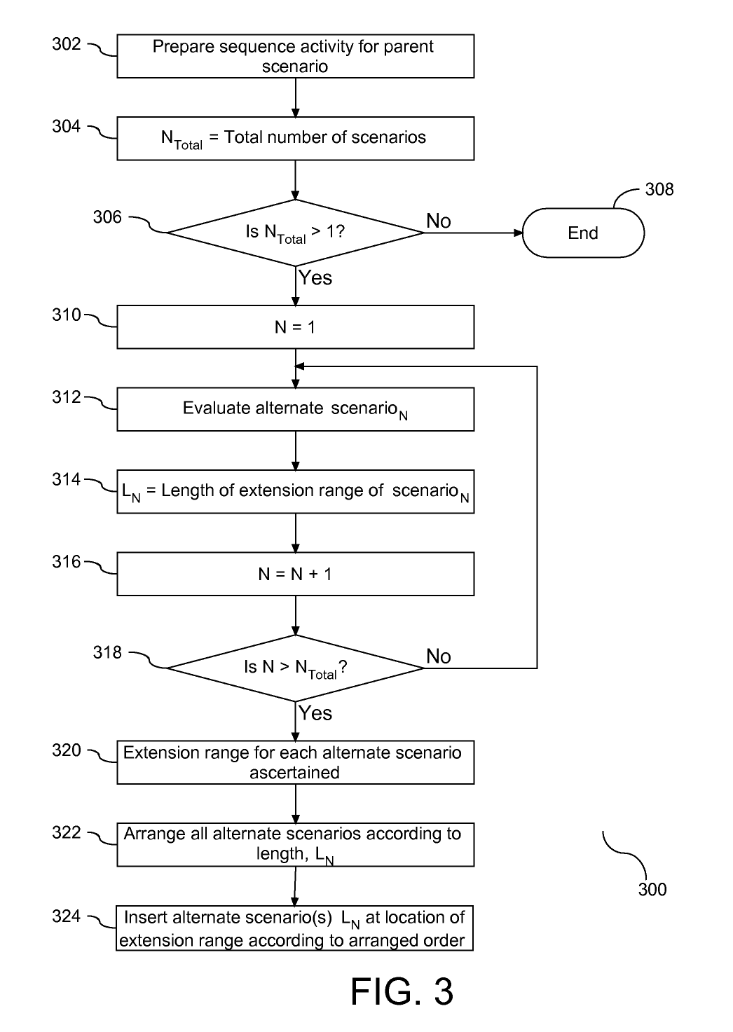

The purpose herein is to transform the usecase description model of FIG. 1 to the process model of FIG. 2. FIG. 3 is a flow chart (300) illustrating a process for transforming the usecase model to the process model. A sequence activity is prepared from the parent scenario (302), i.e. from the basic scenario of the usecase description. This includes preparing the instructive activity of all of the scenario steps and preparing the sequence activity that includes all of the scenario steps. The initial state of the parent scenario is a sequence composed only of instructive activity. Therefore, the initial extension range becomes a single sequence. At the conclusion of the preparation step (302), the total quantity of scenarios is determined and assigned to the variable N_{Total} (304), followed by a determination as to whether there are scenario present beyond the parent scenario (306). In one embodiment, this manifests itself in a test as to whether the variable N_{Total} is greater than the integer one. A negative response to the determination at step (306) completes the preparation step of the transformation process (308). However, a positive response results in assigning the variable N to the integer value one (310) indicating the first alternate scenario. Each alternate scenario N is evaluated (312), and the length of the extension range for scenarioN is determined (314). Following step (314), the variable N is incremented (316) followed by a test to determined if N is greater than N_{Total} (318), i.e. whether there are any more alternate scenarios which require a determination of the extension range. If the response to the determination at step (318) is negative, the process returns to step (312). However, if the response to the determination at step (318) is positive, this is an indication that the extension range for each alternate scenario has been ascertained (320). Following step (320) all of the alternate scenarios are arranged in order according to the length of each extension range, L_{N} (322). If one or more extension ranges have the same length, the value condition is placed at a higher location than the exception condition. Thereafter, the alternate scenarios L_{N} are inserted at the location of the extension range (324) according to the arranged order at step (322). This process is recursively repeated for all alternate scenarios that branch from the parent alternate scenario. Accordingly, the first part of the transformation process is creating a sequence activity from a parent scenario.

The initial state of the parent scenario is a sequence composed only of the instructive activity. This sequence is referred to as a simple sequence. The longest initial extension range becomes the simple sequence. Any two extension ranges are related comprehensively. Therefore, the next extension range also becomes a part of the simple sequence. Accordingly, all of the extension ranges become a part of the simple sequence.

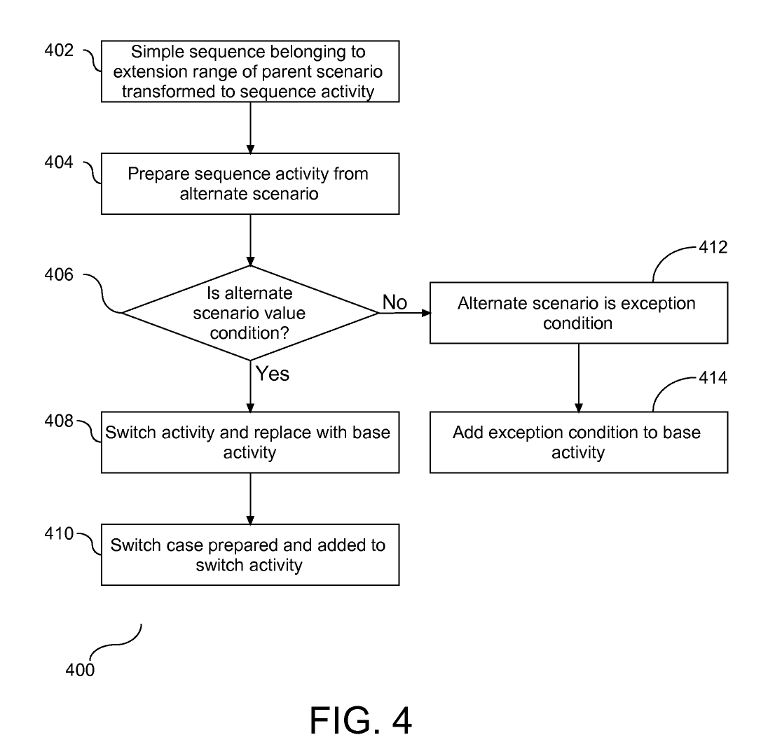

Following the creation of the sequence activity, the alternate scenario(s) need to be inserted to the parent scenario. FIG. 4 is a flow chart (400) illustrating the insertion process. First, the simple sequence belonging to the extension range of the parent scenario is transformed into the sequence activity (402). This is called a base activity. The transformation described at step (402) includes preparing the sequence activity, cutting out the simple sequence at the location of the extension range and putting it into this sequence activity, and replacing the cut out portion with this sequence activity. Following step (402), the sequence activity is prepared from the alternate scenario (404), also known as an alternate activity. When the alternate scenario is the value condition (406), the switch activity is prepared and replaced with the base activity (408), and the switch case is prepared and added to the switch activity (410). When the alternate scenario is the exception condition (412), the exception handler is added to the base activity (414). This designates the activity of the exception handler as the alternate activity. In one embodiment, when there are multiple extension ranges having the same length, those ranges after the second extension with the same length range are considered additions of the switch case or exception handler.

In one embodiment, the invention is implemented in software, which includes but is not limited to firmware, resident software, microcode, etc. The invention can take the form of a computer software product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

Embodiments within the scope of the present invention also include articles of manufacture comprising program storage means having program code encoded therein. Such program storage means can be any available media which can be accessed by a general purpose or special purpose computer. By way of example, and not limitation, such program storage means can include RAM, ROM, EEPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

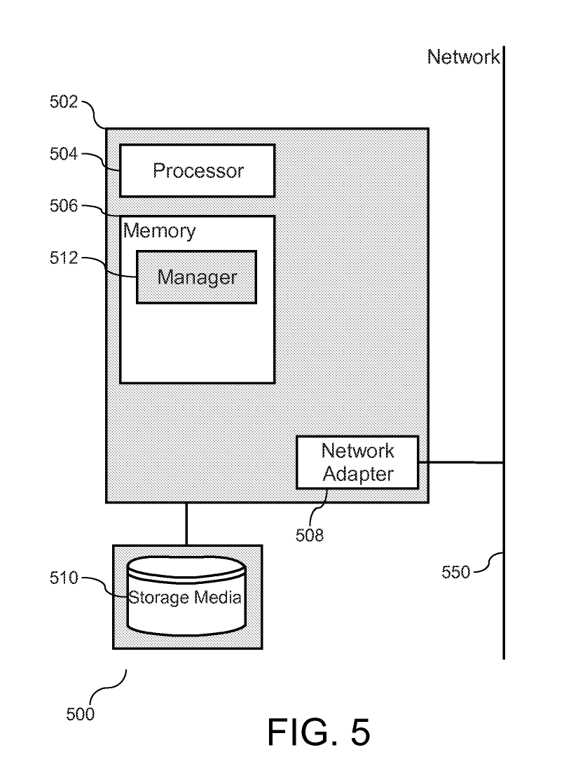

In one embodiment, a manager is provided in software or hardware to transform a usecase model to a process model. With respect to the software implementation, the manager may include, but is not limited to, firmware, resident software, microcode, etc. The software implementation can take the form of a computer program product accessible from a computer-useable or computer-readable medium providing program code for use by or in connection with a computer or any instruction execution system. FIG. 5 is a block diagram (500) illustrating placement of the manager in a computer system. The illustration shows a computing device (502) with a processor (504) and memory (506). As shown, the computing device (502) may communicate across a network (550) through a network adapter (508). A usecase description of a component based layered architecture is stored in computer readable format in the storage media (510) in communication with the computing device (502). In one embodiment, the storage media (510) may be remote data storage (not shown) that is accessible through communications across the network (550). A manager (512) is shown residing in memory (504) of the computer device (502). The manager (512) may implement instructions to transform the usecase model to a process model, wherein the transformation includes the manager expressing a structured flow with conditional branching and exception processing. Accordingly, the transformation technique converts a usecase model to a process model, with the transformation including the manager expressing a structured flow with conditional branching and exception processing.

For the purposes of this description, a computer-useable or computer-readable medium can be any apparatus that can contain, store, communicate, propagate, or transport the program for use by or in connection with the instruction execution system, apparatus, or device.

As shown, network adapters may also be coupled to the system to enable the data processing system to become coupled to other data processing systems or remote printers or storage devices through intervening private or public networks. Modems, wireless and Ethernet adapters are just a few of the currently available types of network adapters.

### Advantages Over the Prior Art

By providing a model and algorithm for generating a process model from the usecase description, development costs of the flow control layer is reduced. Furthermore, generation of the process model improves program development productivity for the flow control. In addition, since it is possible to generate the implementation from the process model, generation of the program from the specification can be automated.

### Alternative Embodiments

It will be appreciated that, although specific embodiments of the invention have been described herein for purposes of illustration, various modifications may be made without departing from the spirit and scope of the invention. In particular, in one embodiment the specification of the flow control of the application by the usecase description is structured as an input, and the usecase description model is constructed by parsing it. Then, the usecase description model is transformed into the process model. The process model has information sufficient to generate the implementation of the flow control by the language provided with the mechanism of the structuring and exception processing. However, this invention does not limit the formality of the input for constructing the usecase description model and the output of the implementation generated from the process model. Accordingly, the scope of protection of this invention is limited only by the following claims and their equivalents.

We claim:

1. A method for generating a process model from a usecase description, comprising:
defining a usecase model for formalizing and expressing a usecase description;
transforming the defined usecase model to a process model, including expressing a structured flow of said usecase model in said process model, wherein said structured flow includes conditional branching and exception processing.

2. The method of claim 1, further comprising said process model generating flow control by language provided with structure and exception processing.

3. The method of claim 1, wherein the step of transforming the defined usecase model to a process model includes preparing a sequence activity from the parent scenario.

4. The method of claim 3, further comprising preparing an instructive activity for all scenario steps and said sequence activity to include all scenario steps.

5. The method of claim 3, further comprising inserting an alternate scenario to said parent scenario following creation of said sequence activity.

6. The method of claim 1, further comprising automating program development from said process model transformed from said usecase model.

7. A computer system, comprising:
a processor in communication with storage media;
a usecase description of a component based layered architecture stored in computer readable format in said storage media; and
a usecase model adapted to formalize and express said usecase description; and
a manger adapted to transform said usecase model to a process model, wherein said transformation includes said manager expressing a structured flow of said usecase model in said process mode, and said structured flow includes conditional branching and exception processing.

8. The system of claim 7, further comprising process model flow control language generated by language provided from structure and exception processing.

9. The system of claim 7, wherein transformation of said usecase model to said process model includes preparation of a sequence activity from a patent scenario by said manager.

10. The system of claim 9, further comprising said manager to prepare an instructive activity for all scenario steps, and said sequence activity to include all scenario steps.

11. The system of claim 9, further comprising said manager to insert an alternate scenario to said parent scenario after creation of said sequence activity.

12. The system of claim 7, further comprising an automation manager to automate program development from said process model transformed from said usecase model.

13. An article comprising:
a computer readable medium having computer-readable instructions stored thereon executable by a processor, comprising:
instructions to define a usecase model for formalizing and expressing a usecase description; and
instructions to transform the defined usecase model to a process model, including instructions to express a structured flow from said usecase description in said process model, said structured flow having conditional branching and exception processing.

14. The article of claim 13, further comprising instructions to generate flow control from said process model by language provided with structure and exception processing.

15. The article of claim 13, wherein the instruction to transform the defined usecase model to a process model includes instructions to prepare a sequence activity from a parent scenario.

16. The article of claim 15, further comprising instructions to prepare an instructive activity for all scenario steps and said sequence activity to include all scenario steps.

17. The article of claim 15, further comprising instructions to insert an alternate scenario to said parent scenario following creation of said sequence activity.

18. The article of claim 13, further comprising instructions to automate program development from said process model transformed from said usecase model.
